(19) United States
(12) Patent Application Publication
(10) Pub. No.: US 2016/0090468 A1
(43) Pub. Date: Mar. 31, 2016

(54) FLAME RETARDANT, FLAME RETARDANT COMPOSITION, AND MOLDED PRODUCT AND MANUFACTURING METHOD THEREOF

(71) Applicant: DOUBLE BOND CHEMICAL IND., CO., LTD., New Taipei City (TW)

(72) Inventors: Chiung-Ta Chen, New Taipei City (TW); Chih-Wei Lin, New Taipei City (TW); Ming-Yang Chien, New Taipei City (TW); En-Ching Wang, New Taipei City (TW); Kuan-Ju Tu, New Taipei City (TW); Maw-Der Tsay, New Taipei City (TW); Liang Lin, New Taipei City (TW)

(21) Appl. No.: 14/601,236

(22) Filed: Jan. 21, 2015

(30) Foreign Application Priority Data
Sep. 26, 2014 (TW) 103133509

(51) Int. Cl. C08K 5/5398; C08L 47/00; C07F 9/145

(52) U.S. Cl. CPC C08K 5/5398; C07F 9/145; C08L 47/00; C08L 2201/02

(57) ABSTRACT

The invention provides a flame retardant, a flame retardant composition, and a molded product and a manufacturing method thereof. The flame retardant has a structure shown in formula (1):

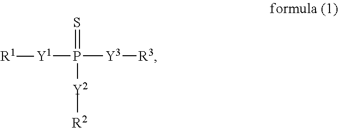

in formula (1), Y¹, Y², and Y³ each independently represent an oxygen atom or a single bond; R¹, R², and R³ each independently represent a C₁ to C₆ alkyl group, a C₃ to C₆ cycloalkyl group, a phenyl group, or a phenyl group in which an arbitrary hydrogen atom is substituted by an alkyl group or a nitro group.

### CROSS-REFERENCE TO RELATED APPLICATION

This application claims the priority benefit of Taiwan application serial no. 103133509, filed on Sep. 26, 2014. The entirety of the above-mentioned patent application is hereby incorporated by reference herein and made a part of this specification.

### BACKGROUND OF THE INVENTION

1. Field of the Invention

The invention relates to a flame retardant, a flame retardant composition, and a molded product and a manufacturing method thereof, and more particularly, to a flame retardant having good flame retardance, a flame retardant composition containing the flame retardant, and a molded product manufactured from the flame retardant composition and a manufacturing method thereof.

2. Description of Related Art

Polymers have been widely applied in different fields such as mechanical parts, office supplies, electronic devices, the auto industry, household appliances, or various circuit boards. To meet the industry's demand for hardness and other properties, the research of various parties is mainly toward mixing a polymer into a composition having a specific property, and then using the polymer in a subsequent application.

Since polymers applied in various electronic devices need to be operated under high-temperature for long periods of time, polymers need to have good flame retardance. Therefore, a flame retardant is generally added in a polymer to form a composition so as to increase the flame retardance of the polymer. In general, the flame retardant is in a specific stage (such as heating, decomposition, ignition, or spreading of flame) of a burning process. Moreover, the flame retardant can be divided into a halogenated flame retardant, a phosphorus-based flame retardant, and inorganic metal-based. However, currently, due to increased environmental awareness, various industries have been committed to the development of a halogen-free flame retardant, wherein a phosphorous-based flame retardant has received the most attention.

China Patent Publication No. 102272216 discloses a flame retardant polymer composition including a mixture of phosphinic acid salt and dihydrophospho-phenantrene (DOPO). A laminate material manufactured from the composition has excellent surface characteristics and reduced layered tendency. Japanese Patent Laid-open No. 2013-96021 discloses an aromatic phosphorus-based flame retardant. When the aromatic phosphorus-based flame retardant is used in an aliphatic polyester fiber structure, the aromatic phosphorus-based flame retardant can provide flame retardance to the aliphatic polyester fiber structure. US Patent Publication No. 2007-0082987 discloses a synergistic flame retardant composition including phosphorus salt and a phosphine compound, and the synergistic flame retardant composition can provide flame retardance to a polymer. However, although many phosphorous-based flame retardants have currently been developed, when the phosphorous-based flame retardants are applied in a polymer, the issue of insufficient flame retardance is still present.

As a result, the development of a phosphorus-based flame retardant suitable to be added in a polymer is urgently needed, so as to solve the issue of insufficient flame retardance of a polymer, and thereby increase the flame retardance properties of the polymer.

### SUMMARY OF THE INVENTION

The invention provides a flame retardant to be added in a polymer, thereby solving the issue of insufficient flame retardance of a polymer.

The invention provides a flame retardant containing a phosphorus-sulfur bond and having a structure shown in formula (1):

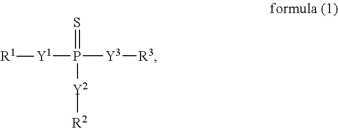

in formula (1), Y¹, Y², and Y³ each independently represent an oxygen atom or a single bond; R¹, R², and R³ each independently represent a C₁ to C₆ alkyl group, a C₃ to C₆ cycloalkyl group, a phenyl group, or a phenyl group in which an arbitrary hydrogen atom is substituted by an alkyl group or a nitro group.

In an embodiment of the invention, in formula (1), Y¹, Y², and Y³ each independently represent an oxygen atom; R¹, R², and R³ each independently represent a C₁ to C₆ alkyl group, a phenyl group, or a phenyl group in which an arbitrary hydrogen atom is substituted by an alkyl group or a nitro group.

In an embodiment of the invention, the flame retardant has a structure shown in formula (2):

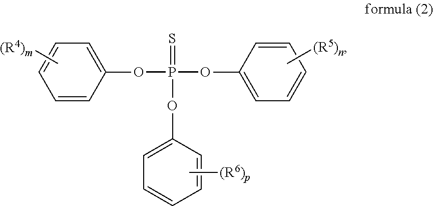

in formula (2), R⁴, R⁵, and R⁶ each independently represent a C₁ to C₁₀ straight-chain or branched-chain alkyl group; and m, n, and p each independently represent an integer of 0 to 5.

The invention provides a flame retardant composition including the flame retardant and a polymer.

In an embodiment of the invention, based on 100 parts by weight of the flame retardant composition, the content of the polymer is 65 parts by weight to 90 parts by weight, and the content of the flame retardant is greater than 5 parts by weight and less than or equal to 35 parts by weight.

In an embodiment of the invention, the polymer includes an acrylonitrile-butadiene-styrene (ABS) copolymer, thermoplastic polyurethane (TPU), polyethylene (PE), polypropylene (PP), polystyrene (PS), polymethyl methacrylate (PMMA), polyvinyl chloride (PVC), nylon, polycarbonate (PC), polyurethane, polyoxymethylene, polytetrafluoroethylene (PTFE), polyethylene terephthalate (PET), polyisoprene, styrene-butadiene rubber (SBR), butyl rubber, polybutadiene rubber, chloroprene rubber (CR), ethylene propylene diene monomer (EPDM), polyacrylate rubber (ACM), urethane rubber (PU), silicone rubber, fluorinated rubber, or a combination thereof.

In an embodiment of the invention, the flame retardant composition further includes an antioxidant, a heat stabilizer, a UV absorber, a light stabilizer, a colorant, or a combination thereof.

The invention also provides a manufacturing method of a molded product, including performing a molding treatment on the flame retardant composition to form a molded product.

In an embodiment of the invention, in the manufacturing method of a molded product, the molding treatment includes injection molding, extrusion molding, compression molding, blow molding, or cast molding.

The invention further provides a molded product obtained via the manufacturing method of a molded product.

Based on the above, the invention provides a compound containing a phosphorus-sulfur bond as the flame retardant. When the flame retardant is applied in a polymer, the known issue of insufficient flame retardance of a polymer can be effectively alleviated. In other words, the compound of the invention containing a phosphorus-sulfur bond can effectively increase the flame retardance of a polymer.

To make the above features and advantages of the invention more comprehensible, several embodiments are described in detail as follows.

### DESCRIPTION OF THE EMBODIMENTS

### Flame Retardant

The invention provides a flame retardant containing a phosphorus-sulfur bond and having a structure shown in formula (1):

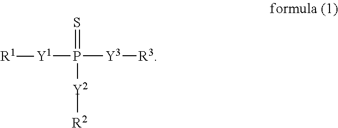

In formula (1), Y¹, Y², and Y³ each independently represent an oxygen atom or a single bond, and preferably each independently represent an oxygen atom;

In formula (1), R¹, R², and R³ each independently represent a C₁ to C₆ alkyl group, a C₃ to C₆ cycloalkyl group, a phenyl group, or a phenyl group in which an arbitrary hydrogen atom is substituted by an alkyl group or a nitro group, and preferably each independently represent a C₁ to C₆ alkyl group, a phenyl group, or a phenyl group in which an arbitrary hydrogen atom is substituted by an alkyl group or a nitro group.

When R¹, R², and R³ each independently represent a C₁ to C₆ alkyl group, the alkyl group can be a straight-chain or branched-chain alkyl group. Specifically, R¹, R², and R³ can each independently represent a methyl group, an ethyl group, an n-propyl group, an isopropyl group, an n-butyl group, an isobutyl group, a tert-butyl group, a tert-pentyl group, an n-pentyl group, an n-hexyl group, or a 1-methylpentyl group.

When R¹, R², and R³ each independently represent a C₃ to C₆ cycloalkyl group, the cycloalkyl group can be a cyclopropyl group, a cyclobutyl group, a cyclopentyl group, or a cyclohexyl group, and an arbitrary hydrogen atom on the cycloalkyl group can be substituted by one or more straight-chain or branched-chain alkyl groups.

When R¹, R², and R³ each independently represent a phenyl group, an arbitrary hydrogen atom on the phenyl group can be substituted by one or more nitro groups or one or more alkyl groups, wherein the alkyl group can be a C₁ to C₂₀ straight-chain or branched-chain alkyl group.

Specifically, specific examples of the flame retardant containing a phosphorous-sulfur bond and having the structure shown in formula (1) are as shown in Table 1.

TABLE 1

| Number | Y¹ | Y² | Y³ | R¹ | R² | R³ |
|---|---|---|---|---|---|---|
| 1 | Oxygen | Oxygen | Oxygen | C₁ to C₆ | C₁ to C₆ | C₁ to C₆ |
| | atom | atom | atom | alkyl | alkyl | alkyl |
| | | | | group | group | group |
| 2 | Oxygen | Oxygen | Oxygen | C₃ to C₆ | C₁ to C₆ | C₁ to C₆ |
| | atom | atom | atom | cycloalkyl | alkyl | alkyl |
| | | | | group | group | group |
| 3 | Oxygen | Oxygen | Oxygen | C₁ to C₆ | C₃ to C₆ | C₁ to C₆ |
| | atom | atom | atom | alkyl | cycloalkyl | alkyl |
| | | | | group | group | group |
| 4 | Oxygen | Oxygen | Oxygen | Phenyl | C₁ to C₆ | C₁ to C₆ |
| | atom | atom | atom | group | alkyl | alkyl |
| | | | | | group | group |
| 5 | Oxygen | Oxygen | Oxygen | C₁ to C₆ | Phenyl | C₁ to C₆ |
| | atom | atom | atom | alkyl | group | alkyl |
| | | | | group | | group |
| 6 | Oxygen | Oxygen | Oxygen | C₁ to C₆ | C₁ to C₆ | Phenyl |
| | atom | atom | atom | alkyl | alkyl | group |
| | | | | group | group | |
| 7 | Oxygen | Oxygen | Oxygen | Phenyl | C₁ to C₆ | C₁ to C₆ |
| | atom | atom | atom | group in | alkyl | alkyl |
| | | | | which an | group | group |
| | | | | arbitrary | | |
| | | | | hydrogen | | |
| | | | | atom is | | |
| | | | | substituted | | |
| | | | | by an alkyl | | |
| | | | | group | | |
| 8 | Oxygen | Oxygen | Oxygen | C₁ to C₆ | Phenyl | C₁ to C₆ |
| | atom | atom | atom | alkyl | group in | alkyl |
| | | | | group | which an | group |
| | | | | | arbitrary | |
| | | | | | hydrogen | |
| | | | | | atom is | |
| | | | | | substituted | |
| | | | | | by an alkyl | |
| | | | | | group | |
| 9 | Oxygen | Oxygen | Oxygen | C₁ to C₆ | C₁ to C₆ | Phenyl |
| | atom | atom | atom | alkyl | alkyl | group in |
| | | | | group | group | which an |
| | | | | | | arbitrary |
| | | | | | | hydrogen |
| | | | | | | atom is |
| | | | | | | substituted |
| | | | | | | by an alkyl |
| | | | | | | group |
| 10 | Oxygen | Oxygen | Oxygen | Phenyl | C₁ to C₆ | C₁ to C₆ |
| | atom | atom | atom | group in | alkyl | alkyl |
| | | | | which an | group | group |
| | | | | arbitrary | | |
| | | | | hydrogen | | |
| | | | | atom is | | |
| | | | | substituted | | |
| | | | | by a nitro | | |
| | | | | group | | |
| 11 | Oxygen | Oxygen | Oxygen | C₁ to C₆ | Phenyl | C₁ to C₆ |
| | atom | atom | atom | alkyl | group in | alkyl |
| | | | | group | which an | group |
| | | | | | arbitrary | |
| | | | | | hydrogen | |
| | | | | | atom is | |
| | | | | | substituted | |
| | | | | | by a nitro | |
| | | | | | group | |
| 12 | Oxygen | Oxygen | Oxygen | C₁ to C₆ | C₁ to C₆ | Phenyl |
| | atom | atom | atom | alkyl | alkyl | group in |
| | | | | group | group | which an |
| | | | | | | arbitrary |
| | | | | | | hydrogen |
| | | | | | | atom is |
| | | | | | | substituted |
| | | | | | | by a nitro |
| | | | | | | group |
| 13 | Oxygen | Oxygen | Oxygen | Phenyl | Phenyl | Phenyl |
| | atom | atom | atom | group | group | group |
| 14 | Oxygen | Single | Oxygen | C₁ to C₆ | C₁ to C₆ | C₁ to C₆ |
| | atom | bond | atom | alkyl | alkyl | alkyl |
| | | | | group | group | group |
| 15 | Oxygen | Single | Oxygen | C₃ to C₆ | C₁ to C₆ | C₁ to C₆ |
| | atom | bond | atom | cycloalkyl | alkyl | alkyl |
| | | | | group | group | group |
| 16 | Oxygen | Single | Oxygen | C₁ to C₆ | C₃ to C₆ | C₁ to C₆ |
| | atom | bond | atom | alkyl | cycloalkyl | alkyl |
| | | | | group | group | group |
| 17 | Oxygen | Single | Oxygen | Phenyl | C₁ to C₆ | C₁ to C₆ |
| | atom | bond | atom | group | alkyl | alkyl |
| | | | | | group | group |
| 18 | Oxygen | Single | Oxygen | C₁ to C₆ | Phenyl | C₁ to C₆ |
| | atom | bond | atom | alkyl | group | alkyl |
| | | | | group | | group |
| 19 | Oxygen | Single | Oxygen | C₁ to C₆ | C₁ to C₆ | Phenyl |
| | atom | bond | atom | alkyl | alkyl | group |
| | | | | group | group | |
| 20 | Oxygen | Single | Oxygen | Phenyl | C₁ to C₆ | C₁ to C₆ |
| | atom | bond | atom | group in | alkyl | alkyl |
| | | | | which an | group | group |
| | | | | arbitrary | | |
| | | | | hydrogen | | |
| | | | | atom is | | |
| | | | | substituted | | |
| | | | | by an alkyl | | |
| | | | | group | | |
| 21 | Oxygen | Single | Oxygen | C₁ to C₆ | Phenyl | C₁ to C₆ |
| | atom | bond | atom | alkyl | group in | alkyl |
| | | | | group | which an | group |
| | | | | | arbitrary | |
| | | | | | hydrogen | |
| | | | | | atom is | |
| | | | | | substituted | |
| | | | | | by an alkyl | |
| | | | | | group | |
| 22 | Oxygen | Single | Oxygen | C₁ to C₆ | C₁ to C₆ | Phenyl |
| | atom | bond | atom | alkyl | alkyl | group in |
| | | | | group | group | which an |
| | | | | | | arbitrary |
| | | | | | | hydrogen |
| | | | | | | atom is |
| | | | | | | substituted |
| | | | | | | by an alkyl |
| | | | | | | group |
| 23 | Oxygen | Single | Oxygen | Phenyl | C₁ to C₆ | C₁ to C₆ |
| | atom | bond | atom | group in | alkyl | alkyl |
| | | | | which an | group | group |
| | | | | arbitrary | | |
| | | | | hydrogen | | |
| | | | | atom is | | |
| | | | | substituted | | |
| | | | | by a nitro | | |
| | | | | group | | |
| 24 | Oxygen | Single | Oxygen | C₁ to C₆ | Phenyl | C₁ to C₆ |
| | atom | bond | atom | alkyl | group in | alkyl |
| | | | | group | which an | group |
| | | | | | arbitrary | |
| | | | | | hydrogen | |
| | | | | | atom is | |
| | | | | | substituted | |
| | | | | | by a nitro | |
| | | | | | group | |
| 25 | Oxygen | Single | Oxygen | C₁ to C₆ | C₁ to C₆ | Phenyl |
| | atom | bond | atom | alkyl | alkyl | group in |
| | | | | group | group | which an |
| | | | | | | arbitrary |
| | | | | | | hydrogen |
| | | | | | | atom is |
| | | | | | | substituted |
| | | | | | | by a nitro |
| | | | | | | group |
| 26 | Oxygen | Single | Oxygen | Phenyl | Phenyl | Phenyl |
| | atom | bond | atom | group | group | group |
| 27 | Oxygen | Oxygen | Single | C₁ to C₆ | C₁ to C₆ | C₁ to C₆ |
| | atom | atom | bond | alkyl | alkyl | alkyl |
| | | | | group | group | group |
| 28 | Oxygen | Oxygen | Single | C₃ to C₆ | C₁ to C₆ | C₁ to C₆ |
| | atom | atom | bond | cycloalkyl | alkyl | alkyl |
| | | | | group | group | group |
| 29 | Oxygen | Oxygen | Single | C₁ to C₆ | C₃ to C₆ | C₁ to C₆ |
| | atom | atom | bond | alkyl | cycloalkyl | alkyl |
| | | | | group | group | group |
| 30 | Oxygen | Oxygen | Single | Phenyl | C₁ to C₆ | C₁ to C₆ |
| | atom | atom | bond | group | alkyl | alkyl |
| | | | | | group | group |
| 31 | Oxygen | Oxygen | Single | C₁ to C₆ | Phenyl | C₁ to C₆ |
| | atom | atom | bond | alkyl | group | alkyl |
| | | | | group | | group |
| 32 | Oxygen | Oxygen | Single | C₁ to C₆ | C₁ to C₆ | Phenyl |
| | atom | atom | bond | alkyl | alkyl | group |
| | | | | group | group | |
| 33 | Oxygen | Oxygen | Single | Phenyl | C₁ to C₆ | C₁ to C₆ |
| | atom | atom | bond | group in | alkyl | alkyl |
| | | | | which an | group | group |
| | | | | arbitrary | | |
| | | | | hydrogen | | |
| | | | | atom is | | |
| | | | | substituted | | |
| | | | | by an alkyl | | |
| | | | | group | | |
| 34 | Oxygen | Oxygen | Single | C₁ to C₆ | Phenyl | C₁ to C₆ |
| | atom | atom | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by an alkyl | |
| | | | | | group | |
| 35 | Oxygen | Oxygen | Single | C₁ to C₆ | C₁ to C₆ | Phenyl |
| | atom | atom | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by an alkyl |
| | | | | | | group |
| 36 | Oxygen | Oxygen | Single | Phenyl | C₁ to C₆ | C₁ to C₆ |
| | atom | atom | bond | group in | alkyl | alkyl |
| | | | | which an | group | group |
| | | | | arbitrary | | |
| | | | | hydrogen | | |
| | | | | atom is | | |
| | | | | substituted | | |
| | | | | by a nitro | | |
| | | | | group | | |
| 37 | Oxygen | Oxygen | Single | C₁ to C₆ | Phenyl | C₁ to C₆ |
| | atom | atom | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by a nitro | |
| | | | | | group | |
| 38 | Oxygen | Oxygen | Single | C₁ to C₆ | C₁ to C₆ | Phenyl |
| | atom | atom | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by a nitro |
| | | | | | | group |
| 39 | Oxygen | Oxygen | Single | Phenyl | Phenyl | Phenyl |
| | atom | atom | bond | group | group | group |
| 40 | Oxygen | Single | Single | C₁ to C₆ | C₁ to C₆ | C₁ to C₆ |
| | atom | bond | bond | alkyl | alkyl | alkyl |
| | | | | group | group | group |
| 41 | Oxygen | Single | Single | C₃ to C₆ | C₁ to C₆ | C₁ to C₆ |
| | atom | bond | bond | cycloalkyl | alkyl | alkyl |
| | | | | group | group | group |
| 42 | Oxygen | Single | Single | C₁ to C₆ | C₃ to C₆ | C₁ to C₆ |
| | atom | bond | bond | alkyl | cycloalkyl | alkyl |
| | | | | group | group | group |
| 43 | Oxygen | Single | Single | Phenyl | C₁ to C₆ | C₁ to C₆ |
| | atom | bond | bond | group | alkyl | alkyl |
| | | | | | group | group |
| 44 | Oxygen | Single | Single | C₁ to C₆ | Phenyl | C₁ to C₆ |
| | atom | bond | bond | alkyl | group | alkyl |
| | | | | group | | group |
| 45 | Oxygen | Single | Single | C₁ to C₆ | C₁ to C₆ | Phenyl |
| | atom | bond | bond | alkyl | alkyl | group |
| | | | | group | group | |
| 46 | Oxygen | Single | Single | Phenyl | C₁ to C₆ | C₁ to C₆ |
| | atom | bond | bond | group in | alkyl | alkyl |
| | | | | which an | group | group |
| | | | | arbitrary | | |
| | | | | hydrogen | | |
| | | | | atom is | | |
| | | | | substituted | | |
| | | | | by an alkyl | | |
| | | | | group | | |
| 47 | Oxygen | Single | Single | C₁ to C₆ | Phenyl | C₁ to C₆ |
| | atom | bond | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by an alkyl | |
| | | | | | group | |
| 48 | Oxygen | Single | Single | C₁ to C₆ | C₁ to C₆ | Phenyl |
| | atom | bond | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by an alkyl |
| | | | | | | group |
| 49 | Oxygen | Single | Single | Phenyl | C₁ to C₆ | C₁ to C₆ |
| | atom | bond | bond | group in | alkyl | alkyl |
| | | | | which an | group | group |
| | | | | arbitrary | | |
| | | | | hydrogen | | |
| | | | | atom is | | |
| | | | | substituted | | |
| | | | | by a nitro | | |
| | | | | group | | |
| 50 | Oxygen | Single | Single | C₁ to C₆ | Phenyl | C₁ to C₆ |
| | atom | bond | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by a nitro | |
| | | | | | group | |
| 51 | Oxygen | Single | Single | C₁ to C₆ | C₁ to C₆ | Phenyl |
| | atom | bond | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by a nitro |
| | | | | | | group |
| 52 | Oxygen | Single | Single | Phenyl | Phenyl | Phenyl |
| | atom | bond | bond | group | group | group |
| 53 | Single | Oxygen | Single | C₁ to C₆ | C₁ to C₆ | C₁ to C₆ |
| | bond | atom | bond | alkyl | alkyl | alkyl |
| | | | | group | group | group |
| 54 | Single | Oxygen | Single | C₃ to C₆ | C₁ to C₆ | C₁ to C₆ |
| | bond | atom | bond | cycloalkyl | alkyl | alkyl |
| | | | | group | group | group |
| 55 | Single | Oxygen | Single | C₁ to C₆ | C₃ to C₆ | C₁ to C₆ |
| | bond | atom | bond | alkyl | cycloalkyl | alkyl |
| | | | | group | group | group |
| 56 | Single | Oxygen | Single | Phenyl | C₁ to C₆ | C₁ to C₆ |
| | bond | atom | bond | group | alkyl | alkyl |
| | | | | | group | group |
| 57 | Single | Oxygen | Single | C₁ to C₆ | Phenyl | C₁ to C₆ |
| | bond | atom | bond | alkyl | group | alkyl |
| | | | | group | | group |
| 58 | Single | Oxygen | Single | C₁ to C₆ | C₁ to C₆ | Phenyl |
| | bond | atom | bond | alkyl | alkyl | group |
| | | | | group | group | |
| 59 | Single | Oxygen | Single | Phenyl | C₁ to C₆ | C₁ to C₆ |
| | bond | atom | bond | group in | alkyl | alkyl |
| | | | | which an | group | group |
| | | | | arbitrary | | |
| | | | | hydrogen | | |
| | | | | atom is | | |
| | | | | substituted | | |
| | | | | by an alkyl | | |
| | | | | group | | |
| 60 | Single | Oxygen | Single | C₁ to C₆ | Phenyl | C₁ to C₆ |
| | bond | atom | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by an alkyl | |
| | | | | | group | |
| 61 | Single | Oxygen | Single | C₁ to C₆ | C₁ to C₆ | Phenyl |
| | bond | atom | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by an alkyl |
| | | | | | | group |
| 62 | Single | Oxygen | Single | Phenyl | C₁ to C₆ | C₁ to C₆ |
| | bond | atom | bond | group in | alkyl | alkyl |
| | | | | which an | group | group |
| | | | | arbitrary | | |
| | | | | hydrogen | | |
| | | | | atom is | | |
| | | | | substituted | | |
| | | | | by a nitro | | |
| | | | | group | | |
| 63 | Single | Oxygen | Single | C₁ to C₆ | Phenyl | C₁ to C₆ |
| | bond | atom | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by a nitro | |
| | | | | | group | |
| 64 | Single | Oxygen | Single | C₁ to C₆ | C₁ to C₆ | Phenyl |
| | bond | atom | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by a nitro |
| | | | | | | group |
| 65 | Single | Oxygen | Single | Phenyl | Phenyl | Phenyl |
| | bond | atom | bond | group | group | group |
| 66 | Single | Single | Single | C₁ to C₆ | C₁ to C₆ | C₁ to C₆ |
| | bond | bond | bond | alkyl | alkyl | alkyl |
| | | | | group | group | group |
| 67 | Single | Single | Single | C₃ to C₆ | C₁ to C₆ | C₁ to C₆ |
| | bond | bond | bond | cycloalkyl | alkyl | alkyl |
| | | | | group | group | group |
| 68 | Single | Single | Single | C₁ to C₆ | C₃ to C₆ | C₁ to C₆ |
| | bond | bond | bond | alkyl | cycloalkyl | alkyl |
| | | | | group | group | group |
| 69 | Single | Single | Single | Phenyl | C₁ to C₆ | C₁ to C₆ |
| | bond | bond | bond | group | alkyl | alkyl |
| | | | | | group | group |
| 70 | Single | Single | Single | C₁ to C₆ | Phenyl | C₁ to C₆ |
| | bond | bond | bond | alkyl | group | alkyl |
| | | | | group | | group |
| 71 | Single | Single | Single | C₁ to C₆ | C₁ to C₆ | Phenyl |
| | bond | bond | bond | alkyl | alkyl | group |
| | | | | group | group | |
| 72 | Single | Single | Single | Phenyl | C₁ to C₆ | C₁ to C₆ |
| | bond | bond | bond | group in | alkyl | alkyl |
| | | | | which an | group | group |
| | | | | arbitrary | | |
| | | | | hydrogen | | |
| | | | | atom is | | |
| | | | | substituted | | |
| | | | | by an alkyl | | |
| | | | | group | | |
| 73 | Single | Single | Single | C₁ to C₆ | Phenyl | C₁ to C₆ |
| | bond | bond | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by an alkyl | |
| | | | | | group | |
| 74 | Single | Single | Single | C₁ to C₆ | C₁ to C₆ | Phenyl |
| | bond | bond | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by an alkyl |
| | | | | | | group |
| 75 | Single | Single | Single | Phenyl | C₁ to C₆ | C₁ to C₆ |
| | bond | bond | bond | group in | alkyl | alkyl |
| | | | | which an | group | group |
| | | | | arbitrary | | |
| | | | | hydrogen | | |
| | | | | atom is | | |
| | | | | substituted | | |
| | | | | by a nitro | | |
| | | | | group | | |
| 76 | Single | Single | Single | C₁ to C₆ | Phenyl | C₁ to C₆ |
| | bond | bond | bond | alkyl | group in | alkyl |
| | | | | group | which an | group |
| | | | | | arbitrary | |
| | | | | | hydrogen | |
| | | | | | atom is | |
| | | | | | substituted | |
| | | | | | by a nitro | |
| | | | | | group | |
| 77 | Single | Single | Single | C₁ to C₆ | C₁ to C₆ | Phenyl |
| | bond | bond | bond | alkyl | alkyl | group in |
| | | | | group | group | which an |
| | | | | | | arbitrary |
| | | | | | | hydrogen |
| | | | | | | atom is |
| | | | | | | substituted |
| | | | | | | by a nitro |
| | | | | | | group |
| 78 | Single | Single | Single | Phenyl | Phenyl | Phenyl |
| | bond | bond | bond | group | group | group |

The flame retardant more preferably has a structure shown in formula (2):

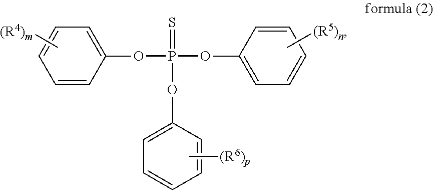

in formula (2), R⁴, R⁵, and R⁶ each independently represent a C₁ to C₁₀ straight-chain or branched-chain alkyl group; and m, n, and p each independently represent an integer of 0 to 5.

When R⁴, R⁵, and R⁶ each independently represent a C₁ to C₁₀ straight-chain or branched-chain alkyl group, R⁴, R⁵, and R⁶ can each independently represent a methyl group, an ethyl group, an n-propyl group, an isopropyl group, an n-butyl group, an isobutyl group, a tert-butyl group, a tert-pentyl group, an n-pentyl group, an n-hexyl group, an n-heptyl group, an n-octyl group, an isooctyl group, 2-ethylhexyl, an n-nonyl group, an isononyl group, or an n-decyl group.

Specific examples of the flame retardant include a compound shown in formula (2-1), a compound shown in formula (2-2), or a combination of the two.

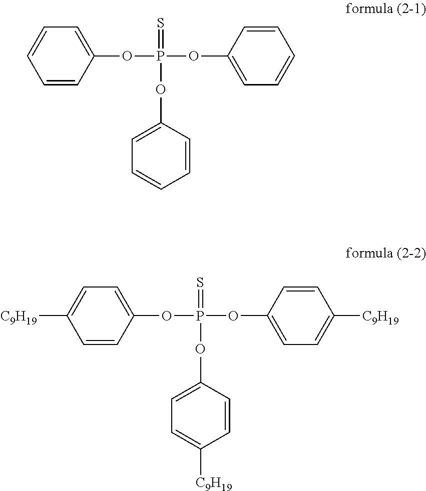

### <Flame Retardant Composition>

The invention provides a flame retardant composition including a flame retardant and a polymer.

The flame retardant is described above and is not repeated herein. When the flame retardant composition contains the flame retardant containing a phosphorous-sulfur bond, the flame retardance of a polymer can be effectively increased.

Based on 100 parts by weight of the flame retardant composition, the content of the flame retardant is greater than 5 parts by weight and less than or equal to 35 parts by weight, preferably greater than 5 parts by weight and less than or equal to 25 parts by weight, and more preferably greater than 15 parts by weight and less than or equal to 25 parts by weight. When the content of the flame retardant is greater than 5 parts by weight and less than or equal to 35 parts by weight, mechanical properties (such as tensile strength or impact strength) of a molded product formed by the flame retardant composition can be further increased.

Specific examples of the polymer include an acrylonitrile-butadiene-styrene copolymer, thermoplastic polyurethane, polyethylene, polypropylene, polystyrene, polymethyl methacrylate, polyvinyl chloride, nylon, polycarbonate, polyurethane, polyoxymethylene, polytetrafluoroethylene, polyethylene terephthalate, polyisoprene, styrene-butadiene rubber, butyl rubber, polybutadiene rubber, chloroprene rubber, ethylene propylene diene monomer, polyacrylate rubber, urethane rubber, silicone rubber, fluorinated rubber, or a combination thereof.

Based on 100 parts by weight of the flame retardant composition, the content of the polymer is 65 parts by weight to 95 parts by weight, preferably 75 parts by weight to 95 parts by weight, and more preferably 75 parts by weight to 85 parts by weight.

If needed, without affecting the efficacy of the invention, an additive can also be added in the flame retardant composition, wherein the additive includes an antioxidant, a heat stabilizer, a UV absorber, a light stabilizer, a colorant, or a combination thereof.

Specific examples of the antioxidant include alkylated monophenol, alkylthio methylphenol, hydroquinone and alkylated hydroquinone, tocopherol, hydroxylated thiosulfate diphenyl ether, alkylidene bisphenol, O-, N-, and S-benzyl compound, hydroxybenzyl malonate, aromatic hydroxybenzyl compound, triazine compound, benzyl phosphonates, acylamino phenol, ester of β-(3,5-ditert-butyl-4-hydroxyphenyl)propionic acid with mono- or polyhydric alcohol, ester of β-(5-tert-butyl-4-hydroxy-3-methylphenyl)propionic acid with mono- or polyhydric alcohol, ester of β-(3,5-dicyclohexyl-4-hydroxyphenyl)propionic acid with mono- or polyhydric alcohol, ester of 3,5-di-tert-butyl-4-hydroxyphenyl acetic acid with mono- or polyhydric alcohol, amide of β-(3,5-di-tert-butyl-4-hydroxyphenyl)propionic acid, ascorbic acid, hindered phenol-type, phosphite, phosphonite, or an amine antioxidant.

Specific examples of the alkylated monophenol include 2,6-di-tert-butyl-4-methylphenol, 2-tert-butyl-4,6-xylenol, 2,6-di-tert-butyl-4-ethylphenol, 2,6-di-tert-butyl-4-n-butylphenol, 2,6-di-tert-butyl-4-isobutylphenol, 2,6-di-tert-butyl-4-sec-butylphenol, 2,6-di-tert-butyl-4-nonylphenol, 2,6-dicyclopentyl-4-methylphenol, 2-(α-methylcyclohexyl)-4,6-xylenol, 2,6-di-octadecyl-4-methylphenol, 2,4,6-tricyclohexylphenol, 2,6-di-tert-butyl-4-methoxymethylphenol, straight-chain or branched-chain nonylphenol in a side chain, such as 2,6-dinonyl-4-methylphenol, 2,4-dimethyl-6-(1′-methylundecane-1′-yl)phenol, 2,4-dimethyl-6-(1′-methylheptadecane-1′-yl)phenol, 2,4-dimethyl-6-(1′-methyltridecane-r-yl)phenol, a similar compound thereof, or a combination of the compounds.

Specific examples of the alkylthio methylphenol include 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol, a similar compound thereof, or a combination of the compounds.

Specific examples of the hydroquinone and the alkylated hydroquinone include 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate, a similar compound thereof, or a combination of the compounds.

Specific examples of the tocopherol include α-tocopherol, β-tocopherol, γ-tocopherol, δ-tocopherol, a mixture (vitamin E) thereof, a similar compound thereof, or a combination of the compounds.

Specific examples of the hydroxylated thiodiphenyl ether include 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide, a similar compound thereof, or a combination of the compounds.

Specific examples of alkylidene bisphenol include 2,2′-methylenebis(6-tert-butyl-4-methylphenol), 2,2′-methylenebis(6-tert-butyl-4-ethylphenol), 2,2′-methylenebis(4-methyl-6-(α-methylcyclohexyl)phenol), 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis(6-(α-methylbenzyl)-4-nonylphenol), 2,2′-methylenebis(6-(α,α-dimethylbenzyl)-4-nonylphenol), 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis(3,3-bis(3′-tert-butyl-4′-hydroxyphenyl)butyrate), bis(3-tert-butyl-4-hydroxy-5-methylphenyl)dicyclopentadiene, bis(2-(3′-tert-butyl-2′-hydroxy-5′-methylbenzyl)-6-tert-butyl-4-methylphenyl)terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane, a similar compound thereof, or a combination of the compounds.

Specific examples of the O-, N-, and S-benzyl compound include 3,5,3′,5′-tetra-tert-butyl-4,4′-dihydroxydianisole, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate, a similar compound thereof, or a combination of the compounds.

Specific examples of the hydroxybenzyl malonate include di-octadecyl-2,2-bis(3,5-di-tert-butyl-2-hydroxybenzyl)malonate, di-octadecyl-2-(3-tert-butyl-4-hydroxy-5-methylbenzyl)malonate, di-octadecylmercaptoethyl-2,2-bis(3,5-di-tert-butyl-4-hydroxybenzyl)malonate, bis(4-(1,1,3,3-tetramethylbutyl)phenyl)-2,2-bis(3,5-di-tert-butyl-4-hydroxybenzyl)malonate, a similar compound thereof, or a combination of the compounds.

Specific examples of the aromatic hydroxybenzyl compound include 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol, a similar compound thereof, or a combination of the compounds.

Specific examples of the triazine compound include 2,4-bis(octylmercapto)-6-bis(3,5-di-tert-butyl-4-hydroxyanilino)-1,3,5-triazine, 2-oetylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, a similar compound thereof; or a combination of the compounds.

Specific examples of the benzyl phosphonates include dimethyl-2,5-di-tert-butyl-4-hydroxybenzyl phosphonate, diethyl-3,5-di-tert-butyl-4-hydroxybenzyl phosphonate, di-octadecyl-3,5-di-tert-butyl-4-hydroxybenzyl phosphonate, di-octadecyl-5-tert-butyl-4-hydroxy-3-methylbenzyl phosphonate, a similar compound thereof; or a combination of the compounds.

Specific examples of the acylamino phenol include 4-hydroxylauranilide, 4-hydroxystearanilide, octyl N-(3,5-di-tert-butyl-4-hydroxyphenyl)carbamate, a similar compound thereof, or a combination of the compounds.

An ester of β-(3,5-di-tert-butyl-4-hydroxyphenyl)propionic acid with mono- or polyhydric alcohol, wherein the mono- or polyhydric alcohol is, for instance, methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phosphoryl-2,6,7-trioxabicyclo[2.2.2]octane; a C₁₃ to C₁₅ alkyl ester (CAS Reg. No. 171090-93-0) of β-(3,5-di-tert-butyl-4-hydroxyphenyl)propionic acid, a similar compound thereof, or a combination of the compounds.

An ester of β-(5-tert-butyl-4-hydroxy-3-methylphenyl)propionic acid with mono- or polyhydric alcohol, wherein the mono- or polyhydric alcohol is, for instance, methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phosphoryl-2,6,7-trioxabicyclo[2.2.2]octane; 3,9-bis(2-(3-(3-tert-butyl-4-hydroxy-5-methylphenyl)propionyloxy)-1,1-dimethylethyl)-2,4,8,10-tetraoxaspiro[5.5]undecane, a similar compound thereof, or a combination of the compounds.

An ester of β-(3,5-dicyclohexyl-4-hydroxyphenyl)propionic acid with mono- or polyhydric alcohol, wherein the mono- or polyhydric alcohol is, for instance, methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phosphoryl-2,6,7-trioxabicyclo[2.2.2]octane, a similar compound thereof, or a combination of the compounds.

An ester of 3,5-di-tert-butyl-4-hydroxyphenyl acetic acid with mono- or polyhydric alcohol, wherein the mono- or polyhydric alcohol is, for instance, methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phosphoryl-2,6,7-trioxabicyclo[2.2.2]octane, a similar compound thereof, or a combination of the compounds.

Specific examples of the amide of β-(3,5-di-tert-butyl-4-hydroxyphenyl)propionic acid include N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis(2-(3-(3,5-di-tert-butyl-4-hydroxyphenyl)propionyloxy)ethyl)oxamide (Naugard XL-1, provided by Uniroyal), a similar compound thereof, or a combination of the compounds.

Ascorbic Acid (Vitamin C).

Specific examples of the aminic antioxidant include N,N′-di-isopropyl-p-phenylenediamine, N,N′-di-sec-butyl-p-phenylenediamine, N,N′-bis(1,4-dimethylphenyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylene-diamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, 4,4′-bis(α,α-dimethylbenzyl)diphenylamine, a reaction product of N-phenylaniline, isobutylene, and 2,4,4-trimethyl pentene, octylated diphenylamine such as p,p′-di-tert-octyldiphenylamine, 4-n-butylaminophenol, 4-butynylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis((2-methylphenyl)amino)ethane, 1,2-bis(phenylamino)propane, (o-tolyl)biguanide, bis(4-(1′,3′-dimethylbutyl)phenyl)amine, tert-butylated N-phenyl-1-naphthylamine, a mixture of monoalkylated and dialkylated tert-butyl/tert-octyldiphenylamines, a mixture of monoalkylated and dialkylated nonyldiphenylamines, a mixture of monoalkylated and dialkylated dodecyldiphenylamines, a mixture of monoalkylated and dialkylated isopropyl/isohexyldiphenylamines, a mixture of monoalkylated and dialkylated tert-butyldiphenylamines, 2,3-dihydro-3,3-dimethyl-4H-1,4-benzothiazine, phenothiazine, a mixture of monoalkylated and dialkylated tert-butyl/tert-octylphenothiazines, a mixture of monoalkylated and dialkylated tert-octyl-phenothiazines, N-allylphenothiazine, N,N,N′,N′-tetraphenyl-1,4-diaminobut-2-ene, a similar compound thereof, or a combination of the compounds.

Specific examples of the hindered phenol include pentaerythritol tetrakis(β-(3,5-di-tert-butyl-4-hydroxyphenyl)propionate (product name: antioxidant 1010); octadecyl 3,5-di-tert-butyl-4-hydroxyphenylpropionate (product name: antioxidant 1076); 2,2′-thio-ethylene glycol bis(β-(3,5-di-tert-butyl-4-hydroxyphenyl propionic acid)ester (product name: antioxidant 1035); 3,5-di-tert-butyl; 4-hydroxyphenyl propionic acid isooctanol ester (product name: antioxidant 1135), commercial products Chinox 1010, Chinox 1076, or Chinox 35 (made by Double Bond Chemical Ind., Co., Ltd.), or a combination of the compounds.

Specific examples of the phosphite ester and the phosphonite include triphenyl phosphite, diphenylalkyl phosphite, phenyldialkyl phosphite, tris(nonylphenyl)phosphite, tridecyl phosphite, triundecyl phosphite, tridodecyl phosphite, trioctadecyl phosphite, distearylpentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz(d,g)-1,3,2-dioxaphosphocin, bis(2,4-di-tert-butyl-6-methyl-phenyl)methyl phosphite, bis(2,4-di-tert-butyl-6-methylphenyl)ethyl phosphite, 6-fluoro-2,4,8,10-tetra-tert-butyl-12-methyl-dibenz(d,g)-1,3,2-dioxaphosphocin, 2,2′,2″-nitrilo(triethyltris(3,3′,5,5′-tetra-tert-butyl-1,1′-biphenyl-2,2′-diyl)phosphite), 2-ethylhexyl(3,3′,5,5′-tetra-tert-butyl-1,1′-biphenyl-2,2′-diyl)phosphite, 5-butyl-5-ethyl-2-(2,4,6-tri-tert-butyl-phenoxy)-1,3,2-dioxaphosphirane, commercial products Chinox 168 or Chinox 618 (made by Double Bond Chemical Ind., Co., Ltd.) a similar compound thereof, or a combination of the compounds.

Specific examples of the heat stabilizer include basic lead salt, fatty acid soap, organotin, an organic auxiliary stabilizer, a composite stabilizer, a hindered amine compound, or a combination thereof.

Specific examples of the base lead salt include tribasic lead carbonate, dibasic lead phosphate, or a combination of the compounds.

Specific examples of the fatty acid soap include cadmium, barium, calcium, zinc, or magnesium salt of stearic acid and lauric acid. Moreover, cadmium soap and barium soap, and calcium soap and zinc soap are often used together to generate a synergistic effect.

Specific examples of the organotin include isooctyl dimercaptoacetate, di-n-octyl tin, or a combination of the compounds.

Specific examples of the organic auxiliary stabilizer include phosphite and an epoxy compound.

Specific examples of the composite stabilizer include cadmium-barium (zinc), barium-zinc resistant to sulfide contamination, non-toxic calcium-zinc, and an organotin complex.

Specific examples of the UV absorber and the light stabilizer include 2-(2′-hydroxyphenyl)benzotriazole, 2-hydroxybenzophenone, ester of substituted or unsubstituted benzoic acid, acrylate, a nickel compound, hindered amine, oxamide, 2-(2-hydroxyphenyl)-1,3,5-triazine, commercial products Chisorb 5411, Chisorb 234, Chisorb 971, Chisorb 292, or Chisorb 622 (made by Double Bond Chemical Ind., Co., Ltd.), or a combination of the compounds.

Specific examples of the 2-(2′-hydroxy)benzotriazole include 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-(2-(2-ethylhexyloxy)carbonylethyl)-2′-hydroxyphenyl)-5-chlorobenz otriazole, 2-(3′-tert-butyl-2′-hydroxy-5′-(2-methoxycarbonylethyl)-phenyl)-5-chlorobenzotriazole, 2-(3′-tert-butyl-2′-hydroxy-5′-(2-methoxycarbonylethyl)-phenyl)benzotriazole, 2-(3′-tert-butyl-2′-hydroxy-5′-(2-octyloxycarbonylethyl)phenyl)benzotriazole, 2-(3′-tert-butyl-5′-(2-(2-ethylhexyloxy)carbonylethyl)-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenyl)benzotriazole, 2,2′-methylenebis(4-(1,1,3,3-tetramethylbutyl)-6-benzotriazole-2-phenol); the transesterification product of 2-(3′-tert-butyl-5′-(2-methoxycarbonylethyl)-2′-hydroxyphenyl)-2H-benzotriazole and polyethylene glycol 300,

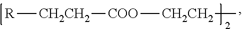

wherein R=3′-tert-butyl-4′-hydroxy-5′-2H-benzotriazol-2-ylphenyl, 2-(2′-hydroxy-3′-(α,α-dimethylbenzyl)-5′-(1,1,3,3-tetramethylbutyl)phenyl)benzotriazole, 2-(2′-hydroxy-3′-(1,1,3,3-tetramethylbutyl)-5′-(α,α-dimethylbenzyl)phenyl)benzotriazole, a similar compound thereof, or a combination of the compounds.

Specific examples of the 2-hydroxybenzophenone include 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives, a similar compound thereof, or a combination of the compounds.

Specific examples of the ester of substituted or unsubstituted benzoic acid include 4-tert-butyl-phenylsalicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate, a similar compound thereof, or a combination of the compounds.

Specific examples of the acrylate include ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate, N-(β-carbomethoxy-β-cyanovinyl)-2-methylindoline, neopentyl tetra(α-cyano-β,β-diphenyl)acrylate, a similar compound thereof, or a combination of the compounds.

Specific examples of the nickel compound include a nickel complex of 2,2′-thio-bis(4-(1,1,3,3-tetramethylbutyl)phenol) with or without an additional ligand (such as n-butylamine, triethanolamine, or N-cyclohexyl diethanolamine), such as a 1:1 or 1:2 complex, dibutyl dithio carbamic acid nickel, nickel salt of monoalkyl ester (such as methyl ester or ethyl ester) of 4-hydroxy-3,5-di-tert-butyl benzyl phosphonic acid, a nickel complex of ketoxime (such as 2-hydroxy-4-methylphenyl undecyl ketoxime), a nickel complex of 1-phenyl-4-lauroyl-5-hydroxypyrazole with or without an additional ligand, a similar compound thereof, or a combination of the compounds.

Specific examples of the sterically hindered amine include bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, a condensate of 1-(2-hydroxyethyl)-2,2,6,6-tetramethyl-4-hydroxypiperidine and succinic acid, a linear or cyclic condensate of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)triacetate, tetrakis(2,2,6,6-tetramethyl-4-piperidyl)-1,2,3,4-butanetetracarboxylate, 1,1′-(1,2-ethanediyl)-bis(3,3,5,5-tetramethyl-4-hexahydropiperazinone), 4-benzoyl-2,2,6,6-tetramethylpiperidine, stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, a linear or cyclic condensate of N,N′-bis(2,2,6,6-tetramethyl-4-piperidyl)hexamethylenediamine and 4-morpholino-2,6-dichloro-1,3,5-triazine, a condensate of 2-chloro-4,6-bis(4-n-butylamino-2,2,6,6-tetramethylpiperidyl)-1,3,5-triazine and 1,2-bis(3-aminopropylamino)ethane, a condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-pentamethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy-2,2,6,6-tetramethylpiperidine and 4-stearyloxy-2,2,6,6-tetramethylpiperidine, a condensate of N,N′-bis(2,2,6,6-tetramethyl-4-piperidyl)-hexamethylenediamine and 4-cyclohexylamino-2,6-dichloro-1,3,5-triazine, a condensate of 1,2-bis(3-aminopropylamino)ethane, 2,4,6-trichloro-1,3,5-triazine, and 4-butylamino-2,2,6,6-tetramethylpiperidine (CAS Reg. No. 136504-96-6), a condensate of 1,6-hexanediamine, 2,4,6-trichloro-1,3,5-triazine, N,N-dibutylamine, and 4-butylamino-2,2,6,6-tetramethylpiperidine (CAS Reg. No. 192268-64-7), N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylene-malonic acid and 1,2,2,6,6-pentamethyl-4-hydroxypiperidine, poly(methylpropyl-3-oxy-4-(2,2,6,6-tetramethyl-4-piperidyl))siloxane, a reaction product of a maleic acid anhydride-α-olefin copolymer and 2,2,6,6-tetramethyl-4-aminopiperidine or 1,2,2,6,6-pentamethyl-4-aminopiperidine, 2,4-bis(N-(1-cyclohexyloxy-2,2,6,6-tetramethylpiperidine-4-yl)-N-butylamino)-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1), 5-(2-ethylhexanoyl)oxymethyl-3,3,5-trimethyl-2-morpholinone, a reaction product of 2,4-bis((1-cyclohexyloxy-2,2,6,6-piperidine-4-yl)butylamino)-6-chloro-s-triazine and N,N′-bis(3-aminopropyl)ethylenediamine), 1,3,5-tris(N-cyclohexyl-N-(2,2,6,6-tetramethylhexahydropiperazine-3-one-4-yl)amino)-s-triazine, 1,3,5-tris(N-cyclohexyl-N-(1,2,2,6,6-pentamethylhexahydropiperazine-3-one-4-yl)amino)-s-triazine, a similar compound thereof, or a combination of the compounds.

Specific examples of the oxamide include 4,4′-dioctyloxyoxanilide, 2,2′-diethoxyoxanilide, 2,2′-dioctyloxy-5,5′-di-tert-butoxanilide, 2,2′-di-dodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and a mixture thereof with 2-ethoxy-2′-ethyl-5,4′-di-tert-butoxanilide, a mixture of o-methoxy-disubstituted oxanilide and p-methoxy-disubstituted oxanilide and a mixture of o-ethoxy-disubstituted oxanilide and p-ethoxy-disubstituted oxanilide, a similar compound thereof, or a combination of the compounds.

Specific examples of the 2-(2-hydroxyphenyl)-1,3,5-triazine include 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-(2-hydroxy-4-(2-hydroxy-3-butyloxypropoxy)phenyl)-4,6-bis(2,4-dimethyl)-1,3,5-triazine, 2-(2-hydroxy-4-(2-hydroxy-3-octyloxypropyloxy)phenyl)-4,6-bis(2,4-dimethyl)-1,3,5-triazine, 2-(4-(dodecyloxy/tridecyloxy-2-hydroxypropoxy)-2-hydroxyphenyl)-4,6-bis(2,4-dimethylphenyl)-1,3,5-triazine, 2-(2-hydroxy-4-(2-hydroxy-3-dodecyloxypropoxy)phenyl)-4,6-bis(2,4-dimethyl)phenyl-1,3,5-triazine, 2-(2-hydroxy-4-hexyloxy)phenyl-4,6-diphenyl-1,3,5-triazine, 2-(2-hydroxy-4-methoxy)phenyl-4,6-diphenyl-1,3,5-triazine, 2,4,6-tris(2-hydroxy-4-(3-butoxy-2-hydroxypropoxy)phenyl)-1,3,5-triazine, 2-(2-hydroxyphenyl)-4-(4-methoxyphenyl)-6-phenyl-1,3,5-triazine, 2-(2-hydroxy-4-(3-(2-ethylhexyl-1-oxy)-2-hydroxypropyloxy)phenyl)-4,6-bis(2,4-dimethylphenyl)-1,3,5-triazine, 2,4-bis(4-(2-ethylhexyloxy)-2-hydroxyphenyl)-6-(4-methoxyphenyl)-1,3,5-triazine, a similar compound thereof, or a combination of the compounds.

The colorant includes a dye, an organic pigment, an inorganic pigment, a biological pigment, ink, paint, a colored chemical substance, food coloring, or a combination thereof. Specific examples of the colorant include titanium oxide, iron (III) oxide, graphite, or a phthalocyanine dye.

Moreover, the additive can also include other auxiliary agents such as polytetrafluoroethylene, antimony trioxide, a slip agent, or antacid.

The additive can be used alone or in multiple combinations. Based on 100 parts by weight of the flame retardant composition, the content of the additive is 0 parts by weight to 1.0 part by weight, preferably 0.2 parts by weight to 1.0 part by weight, and more preferably 0.5 parts by weight to 1.0 part by weight.

### <Preparation Method of Flame Retardant Composition>

The flame retardant composition can be obtained by, for instance, performing melting and kneading (a melting and blending method) on a polymer and a flame retardant via, for instance, a uniaxial extruding machine or a biaxial extruding machine, and when needed, an additive can be added. The melting and kneading temperature only needs to be at a temperature suitable for melting and kneading a polymer, and the melting temperature can be set to, for instance, 180° C. to 230° C. The extrusion method is not particularly limited, and can be, for instance, an inflating extrusion method or a T-die extrusion method.

### <Molded Product and Manufacturing Method Thereof>

The invention provides a molded product manufactured from the flame retardant composition. Specifically, the manufacturing method of the molded product includes performing a molding treatment on the flame retardant composition.

The molding treatment includes injection molding, extrusion molding, compression molding, blow molding, or cast molding.

Moreover, the molded product can be used for the manufacture of various products such as an electronic/electrical device or an automatic apparatus part such as a connector and a socket, a junction box, memory, or a stopper.

### SYNTHESIS EXAMPLES OF FLAME RETARDANT

Synthesis example 1 and synthesis example 2 of the flame retardant are described below:

### Synthesis Example 1

The synthesis method of the compound represented by formula (2-1) (hereinafter “flame retardant (A-1)”) is described below.

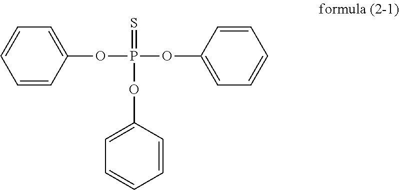 [SMILES: S=P(Oc1ccccc1)(Oc1ccccc1)Oc1ccccc1]

On a four-necked flask having a volume of 1000 mL, a nitrogen inlet, a stirrer, a condenser tube, and a thermometer were provided, and 300 g of triphenyl phosphite (TPP) and 30 g of sulfur were added. Next, under a nitrogen condition, the mixture was stirred and reacted for 4 hours at a temperature of 180° C. (stirring speed: 300 rpm). Then, the temperature of the reaction solution was reduced to 50° C., 300 g of benzene was added, and then the mixture was stirred for 30 minutes (at a temperature of about 50° C.). Then, the solution (organic layer) obtained from the reaction was placed in a separating funnel, and a 3% sodium hydroxide alkaline solution (aqueous layer) was added in the separating funnel. After extraction, the aqueous layer was removed. Lastly, via a distillation method under reduced pressure, 300 g of ethanol was recrystallized and then dried under 45° C. to obtain the flame retardant (A-1).

The structure of the flame retardant (A-1) was confirmed via an NMR measurement.

¹H-NMR (500 MHz, CDCl₃): δ=6.73-7.09 (m, 15H, Ar—H).

### Synthesis Example 2

The synthesis method of the compound represented by formula (2-2) (hereinafter “flame retardant (A-2)”) is described below.

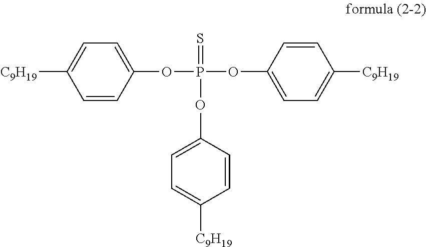

On a four-necked flask having a volume of 2000 mL, a nitrogen inlet, a stirrer, a condenser tube, and a thermometer were provided, and 1200 g of tris(nonylphenyl)phosphite (TNPP) and 55 g of sulfur were added. Next, under a nitrogen condition, the mixture was stirred and reacted for 4 hours at a temperature of 180° C. (stirring speed: 300 rpm). Next, hot filtration was performed under 120° C. to obtain the flame retardant (A-2).

The structure of the flame retardant (A-2) was confirmed via an NMR measurement.

¹H-NMR (500 MHz, CDCl₃): δ=0.9-1.0 (t, 9H, CH) 1.2-1.4 (m, 36H, CH), 1.55-1.65 (m, 6H, CH), 2.50-2.65 (t, 6H, CH), 6.5-6.95 (m, 12H, Ar—H).

### EXAMPLES OF FLAME RETARDANT COMPOSITION

Example 1 to example 11 and comparative example 1 to comparative example 4 of the flame retardant composition are described below:

### Example 1

### a. Flame Retardant Composition

95 parts by weight of an acrylonitrile butadiene styrene (ABS) copolymer, 5 parts by weight of the compound shown in formula (2-1) synthesized in synthesis example 1, 0.3 parts by weight of polytetrafluoroethene (PTFE), and 10 parts by weight of antimony trioxide were placed in a biaxial extruding machine (PSM20A, made by Sinoalloy Machinery Inc.), and then kneading was performed under a melting temperature of 220° C. to 230° C. to obtain the flame retardant composition of example 1.

### b. Test Piece

The flame retardant composition was manufactured into a test piece having a length of 160 mm, a width of 20 mm, and a thickness of 2 mm via an injection molding machine (YH-25, made by Yuh-Dak Machinery Co. Ltd.), wherein the conditions of the injection molding include performing injection molding under a melting temperature of 220° C. to 230° C. The test piece of example 1 was thus obtained. The obtained test piece was evaluated by the following evaluation methods, and the results thereof are as shown in Table 3.

### Example 2 to Example 11

The flame retardant composition and the test piece of each of example 2 to example 11 were prepared using the same steps as example 1, and the difference thereof is: the type of the components and the usage amount thereof were changed (as shown in Table 3), wherein the compounds corresponding to the labels in Table 3 are as shown in Table 2. Moreover, the obtained test pieces were evaluated by the following evaluation methods, and the results thereof are as shown in Table 3.

### Comparative Example 1 to Comparative Example 4

The flame retardant composition and the test piece of each of comparative example 1 to comparative example 4 were prepared using the same steps as example 1, and the difference thereof is: the type of the components and the usage amount thereof were changed (as shown in Table 3), wherein the compounds corresponding to the labels in Table 3 are as shown in Table 2. The obtained test pieces were evaluated by the following evaluation methods, and the results thereof are as shown in Table 3.

### <Evaluation Method of Flame Retardance>

A burn test was performed on five test pieces of each of the examples and the comparative examples according to the UL 94 V-0 vertical burn test standard. The operation steps of the UL 94 V-0 vertical burn test are as follows.

First, the test piece was placed on a sample holder, and surgical cotton was placed 300 mm below the test piece. An ignited Bunsen burner set was placed below the piece to be tested, and a first ignition was performed, and then, after 10 s, the Bunsen burner set was moved. The time needed for the piece to be tested to self-extinguish after the flame was moved was measured and recorded as a first self-extinguishing time. Then, 10 s after the Bunsen burner set was moved, the ignited Bunsen burner was moved below the piece to be tested again, and a second ignition was performed. Then, after 10 s, the Bunsen burner was moved, and the time needed for the piece to be tested to self-extinguish after the flame was moved was measured again and recorded as a second self-extinguishing time. The total burn time refers to the sum of a first burn time and a second burn time measured from a burn test of five test pieces of a single sample. When the maximum self-extinguishing time of each test piece was less than 10 s, the total burn time was 50 s or less, the fire did not spread to the fixture, and the fire may fall dropwise but did not ignite the cotton, which represents that the flame retardant composition passed the UL 94 V-0 vertical burn test standard. When the maximum self-extinguishing time of each test piece was less than 30 s, the total burn time was 50 s or less, the fire did not spread to the fixture, and the fire may fall dropwise but did not ignite the cotton, which represents that the flame retardant composition passed the UL 94 V-1 vertical burn test standard.

TABLE 2

| | Label | Compound |
|---|---|---|
| Flame | A-1 | Compound represented by formula (2-1) |
| retardant | A-2 | Compound represented by formula (2-2) |
| (A) | | |
| Flame | A-3 | Triphenyl phosphite |
| retardant | | |
| (A′) | | |
| Polymer | B-1 | Acrylonitrile-butadiene-styrene (ABS, PA-707, made |
| (B) | | by Chi Mei Corporation) copolymer |
| | B-2 | Nylon6 (SD, made by Libolon) |
| | B-3 | Polypropylene (PP, 6331, made by Luen Fung Hong |
| | | Plastic Materials Co., Ltd.) |
| | B-4 | Thermoplastic urethane (TPU, U85A10, made by |
| | | Bayer Corporation) |
| Additive | Antioxidant C-1 | |
| (C) | C-1-1 | Hindered phenol (Chinox 1010, Chinox 1076, Chinox |
| | | 35, made by Double Bond Chemical Ind., Co., Ltd.) |
| | C-1-2 | Phosphite ester (Chinox 168, Chinox 618, made by |
| | | Double Bond Chemical Ind., Co., Ltd.) |
| | UV absorber C-2 | |
| | C-2-1 | Benzotriazole derivative (Chisorb 5411, Chisorb |
| | | 234, made by Double Bond Chemical Ind., Co., Ltd.) |
| | C-2-2 | Dialkylaminobenzoic ester (Chisorb 971, made by |
| | | Double Bond Chemical Ind., Co., Ltd.) |
| | Light stabilizer C-3 | |
| | C-3-1 | Hindered amine (Chisorb 292, Chisorb 622, made by |
| | | Double Bond Chemical Ind., Co., Ltd.) |
| | Other auxiliary agents C-4 | |
| | C-4-1 | Polytetrafluoroethylene (made by First Cosmetics |
| | | Works) |
| | C-4-2 | Antimony trioxide (made by First Cosmetics Works) |
| | C-4-3 | Slip agent (calcium stearate) |
| | C-4-4 | Antacid (DBC-400, made by Double Bond Chemical |
| | | Ind., Co., Ltd.) |

TABLE 3

| | | Example | | | | | | | | | | | Comparative example | | | |
|---|---|---|---|---|---|---|---|---|---|---|---|---|---|---|---|---|
| Component (unit: parts by weight) | | 1 | 2 | 3 | 4 | 5 | 6 | 7 | 8 | 9 | 10 | 11 | 1 | 2 | 3 | 4 |
| Flame retardant (A) | A-1 | 5 | 10 | 15 | 20 | 15 | 10 | 15 | 10 | 15 | 15 | — | — | — | — | — |
| | A-2 | — | — | — | — | — | — | — | — | — | — | 15 | — | — | — | — |
| Flame retardant (A′) | A-3 | — | — | — | — | — | — | — | — | — | — | — | 15 | 15 | 15 | 15 |
| Polymer (B) | B-1 | 95 | 90 | 85 | 80 | 85 | — | — | — | — | — | — | 85 | — | — | — |
| | B-2 | — | — | — | — | — | — | — | — | — | 85 | — | — | — | 85 | — |
| | B-3 | — | — | — | — | — | — | — | — | — | — | 85 | — | — | — | 85 |
| | B-4 | — | — | — | — | — | 90 | 85 | 90 | 85 | — | — | — | 85 | — | — |
| Additive (C) | C-1-1 | — | — | — | — | 0.2 | — | — | 0.1 | 0.1 | — | 0.1 | 0.2 | 0.1 | — | 0.1 |
| | C-1-2 | — | — | — | — | 0.4 | — | — | 0.2 | 0.2 | — | 0.2 | 0.4 | 0.2 | — | 0.2 |
| | C-2-1 | — | — | — | — | — | — | — | — | — | 0.5 | — | — | — | 0.5 | — |
| | C-2-2 | — | — | — | — | — | — | — | 0.5 | 0.5 | — | — | — | — | — | — |
| | C-3-1 | — | — | — | — | — | — | — | 0.1 | 0.1 | — | 0.2 | — | — | — | 0.2 |
| | C-4-1 | 0.3 | 0.3 | 0.3 | 0.3 | 0.3 | — | — | — | — | — | — | 0.3 | — | — | — |
| | C-4-2 | 10 | 10 | 10 | 10 | 10 | — | — | — | — | — | — | 10 | — | — | — |
| | C-4-3 | — | — | — | — | — | 0.1 | 0.1 | 0.1 | 0.1 | — | 0.1 | — | 0.1 | — | 0.1 |
| | C-4-4 | 0.1 | 0.1 | 0.1 | 0.1 | 0.1 | 0.1 | 0.1 | 0.1 | 0.1 | — | — | 0.1 | 0.1 | — | — |

| | | | | | | | | | | | | | | | |
|---|---|---|---|---|---|---|---|---|---|---|---|---|---|---|---|
| Flame retardance | V1 | V0 | V0 | V0 | V0 | V0 | V0 | V0 | V0 | V0 | V0 | V1 | V1 | V1 | V1 |

### Evaluation Results

It can be known from Table 3 that, in comparison to the flame retardant compositions containing the flame retardant (A) of the invention (example 2 to example 11), the flame retardance of the flame retardant compositions without the flame retardant (A) of the invention (comparative example 1 to comparative example 4) is poor.

Moreover, when the content of the flame retardant (A) of the flame retardant composition of the invention is less than or equal to 5 parts by weight (example 1), the flame retardance of the flame retardant composition is poor.

Based on the above, in the invention, by using the compound containing a phosphorous-sulfur bond as the flame retardant, the known issue of insufficient flame retardance of a polymer can be effectively alleviated.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A flame retardant, having a structure shown in formula (1): 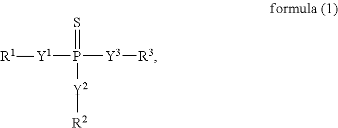
in formula (1), Y¹, Y², and Y³ each independently represent an oxygen atom or a single bond; R¹, R², and R³ each independently represent a C₁ to C₆ alkyl group, a C₃ to C₆ cycloalkyl group, a phenyl group, or a phenyl group in which an arbitrary hydrogen atom is substituted by an alkyl group or a nitro group.

2. The flame retardant of claim 1, wherein in formula (1), Y¹, Y², and Y³ each independently represent an oxygen atom; R¹, R², and R³ each independently represent a C₁ to C₆ alkyl group, a phenyl group, or a phenyl group in which an arbitrary hydrogen atom is substituted by an alkyl group or a nitro group.

3. The flame retardant of claim 1, having a structure shown in formula (2): 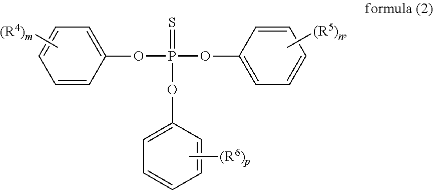
in formula (2), R⁴, R⁵, and R⁶ each independently represent a C₁ to C₁₀ straight-chain or branched-chain alkyl group; and m, n, and p each independently represent an integer of 0 to 5.

4. A flame retardant composition, comprising:
the flame retardant of claim 1; and
a polymer.

5. The flame retardant composition of claim 4, wherein based on 100 parts by weight of the flame retardant composition, a content of the polymer is 65 parts by weight to 90 parts by weight, and a content of the flame retardant is greater than 5 parts by weight and less than or equal to 35 parts by weight.

6. The flame retardant composition of claim 4, wherein the polymer comprises an acrylonitrile-butadiene-styrene copolymer, thermoplastic polyurethane, polyethylene, polypropylene, polystyrene, polymethyl methacrylate, polyvinyl chloride, nylon, polycarbonate, polyurethane, polyoxymethylene, polytetrafluoroethylene, polyethylene terephthalate, polyisoprene, styrene-butadiene rubber, butyl rubber, polybutadiene rubber, chloroprene rubber, ethylene propylene diene monomer, polyacrylate rubber, urethane rubber, silicone rubber, fluorinated rubber, or a combination thereof.

7. The flame retardant composition of claim 4, further comprising an antioxidant, a heat stabilizer, a UV absorber, a light stabilizer, a colorant, or a combination thereof.

8. A manufacturing method of a molded product, comprising performing a molding treatment on the flame retardant composition of claim 4 to form a molded product.

9. The method of claim 8, wherein the molding treatment comprises injection molding, extrusion molding, compression molding, blow molding, or cast molding.

10. A molded product obtained via the method of claim 8.
